(19) United States
(12) Patent Application Publication
(10) Pub. No.: US 2007/0068856 A1
(43) Pub. Date: Mar. 29, 2007

(54) Wastewater treatment apparatus

(76) Inventor: Kevin R. Chaffee, Batesville, IN (US)

Correspondence Address: BAKER & DANIELS LLP, 300 NORTH MERIDIAN STREET, SUITE 2700, INDIANAPOLIS, IN, 46204, US

(21) Appl. No.: 11/301,467

(22) Filed: Dec. 13, 2005

Related U.S. Application Data
(63) Continuation-in-part of application No. 10/348,497, filed on Jan. 21, 2003, now Pat. No. 6,974,536.
Application No. 10/348,497 is a continuation-in-part of application No. 10/019,857, filed on Nov. 9, 2001, now Pat. No. 6,616,832.
Application No. 10/019,857 is a continuation-in-part of application No. 09/309,047, filed on May 10, 1999, now Pat. No. 6,132,599.
(60) Provisional application No. 60/349,262, filed on Jan. 18, 2002.

(51) Int. Cl. B01D 21/24

(52) U.S. Cl. 210/104; 210/139; 210/151; 210/206; 210/264; 210/195.1

(57) ABSTRACT

An apparatus provides for treatment of primary effluent from residential and commercial establishments to allow subsurface or surface disposal of wastewater.

This is a continuation-in-part of U.S. application Ser. No. 10/348,497, filed Jul. 31, 2003, now U.S. Pat. No. 6,974,536, which is a continuation-in-part of U.S. application Ser. No. 10/019,857, filed Nov. 9, 2001, now U.S. Pat. No. 6,616,832, which claims the benefit of PCT International Application No. PCT/US00/12615, filed May 9, 2000, and which is a continuation-in-part of U.S. application Ser. No. 09/309,047, filed May 10, 1999, now U.S. Pat. No. 6,132,599, all of which are expressly incorporated by reference herein. U.S. application Ser. No. 10/348,497 claims the benefit of U.S. Provisional Application No. 60/349,262 which is also incorporated by reference herein.

### BACKGROUND AND SUMMARY OF THE INVENTION

The present invention relates to wastewater treatment systems and improvements thereto. More particularly, this invention relates to an apparatus for treatment of primary effluent from residential and commercial establishments to allow subsurface or surface disposal of wastewater therefrom.

Many areas in this country are experiencing an increase in population accompanied by a larger demand for housing and commercial establishments in rural areas and around major municipalities with no access to a public sewer system. Conventional onsite wastewater systems provide a viable option for managing the wastewater generated by development, however, not all soils are suitable for these systems. Conventional onsite wastewater systems also require a large land area, putting a premium cost on real estate in many locations. In order to maintain a non-hazardous environment, residential and commercial establishments must treat wastewater that they produce. Since public utility wastewater treatment systems and conventional onsite systems are not always available or are not desirable, alternative wastewater treatment methods are often necessary. Due to the premium price on real estate and the high density of residential and commercial building, it is desirable to reduce and minimize the space required for wastewater treatment systems to treat the wastewater to acceptable standards.

According to an illustrated embodiment of the present invention, a wastewater treatment apparatus comprising a recirculation chamber, a dosing chamber having no direct fluid connection to the recirculation chamber, and a filter layer containing a filter media and being located above the recirculation and dosing chambers. The recirculation chamber, the dosing chamber, and the filter layer are located in a single tank. The apparatus also comprises an influent pipe that directs wastewater entering the wastewater treatment apparatus into the recirculation chamber, and a recirculation pump located in the recirculation chamber. The recirculation pump pumps the wastewater from the recirculation chamber onto the filter layer. The apparatus further comprises a septic tank return pipe connected to the dosing chamber, a portion of the wastewater being discharged from the wastewater treatment apparatus through the septic tank return pipe back to a septic tank for additional treatment, and an effluent discharge pipe connected to the dosing chamber. Wastewater is discharged from the wastewater treatment apparatus through the effluent discharge pipe for final disposal.

In an illustrated embodiment, a wastewater treatment unit includes a tank having an interior region, and a divider located in the interior region of the tank to divide the interior region of the tank into two distinct chambers including a recirculation chamber and a dosing chamber having no direct fluid connection to said recirculation chamber. A first filter layer containing filter media is located above said recirculation chamber, and a second filter layer containing filter media is located above said dosing chamber. An influent pipe is provided which directs wastewater entering said wastewater treatment unit into said recirculation chamber. A recirculation pump is located in said recirculation chamber. The recirculation pump pumps the wastewater from the recirculation chamber onto said first and second filter layers. An effluent discharge pipe is connected to said dosing chamber. Wastewater is discharged from said wastewater treatment unit through said effluent discharge pipe for final disposal.

Additional features of the invention will become apparent to those skilled in the art upon consideration of the following detailed description of the best mode of carrying out the invention as presently perceived.

### BRIEF DESCRIPTION OF THE DRAWINGS

The detailed description particularly refers to the accompanying figures in which:

FIG. 1 is a plan view of the wastewater treatment apparatus with riser lids removed;

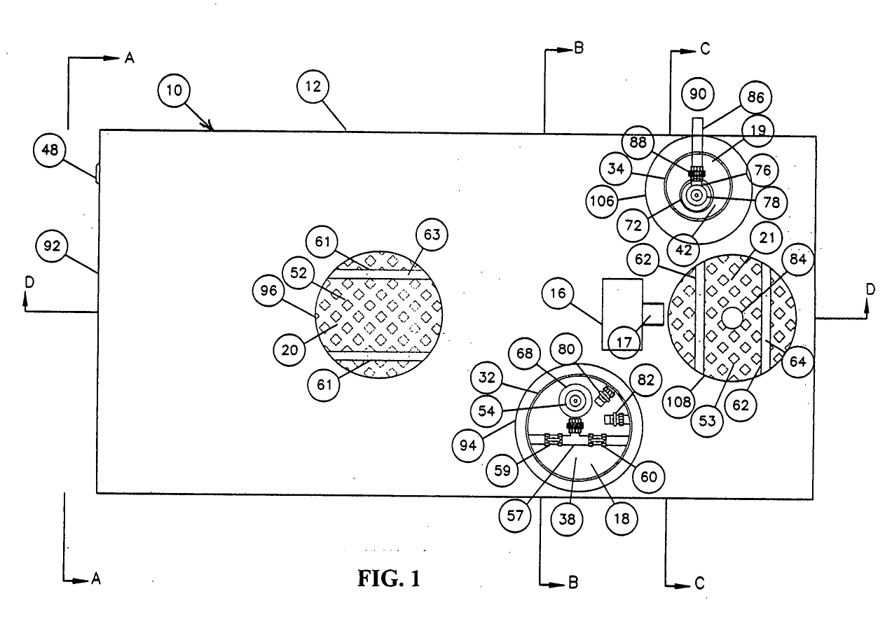

FIG. 2 is an end view taken along lines A-A of FIG. 1;

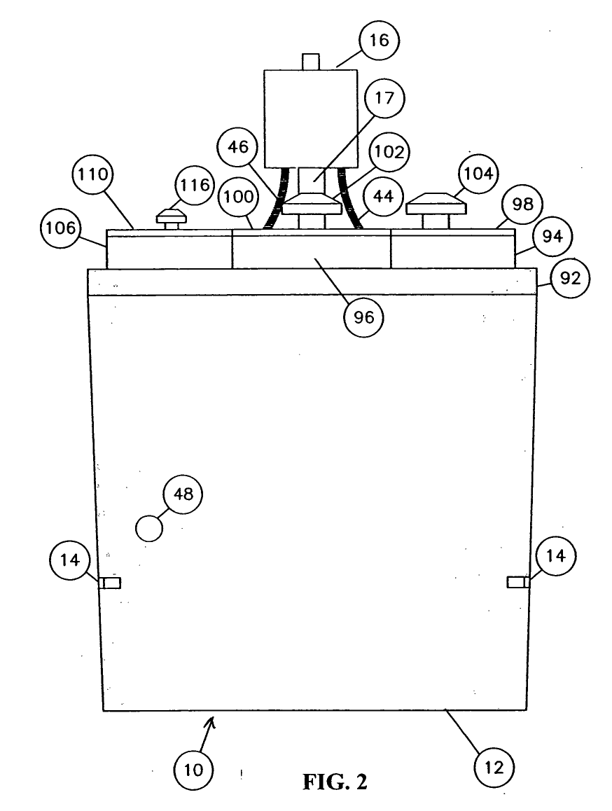

FIG. 3 is a sectional view taken along lines B-B of FIG. 1;

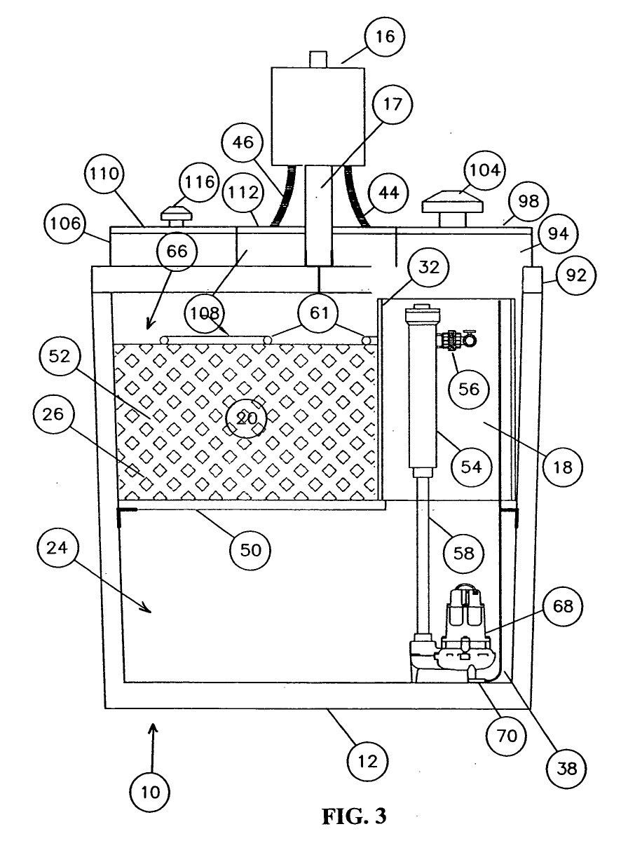

FIG. 4 is a sectional view taken along lines C-C of FIG. 1; and

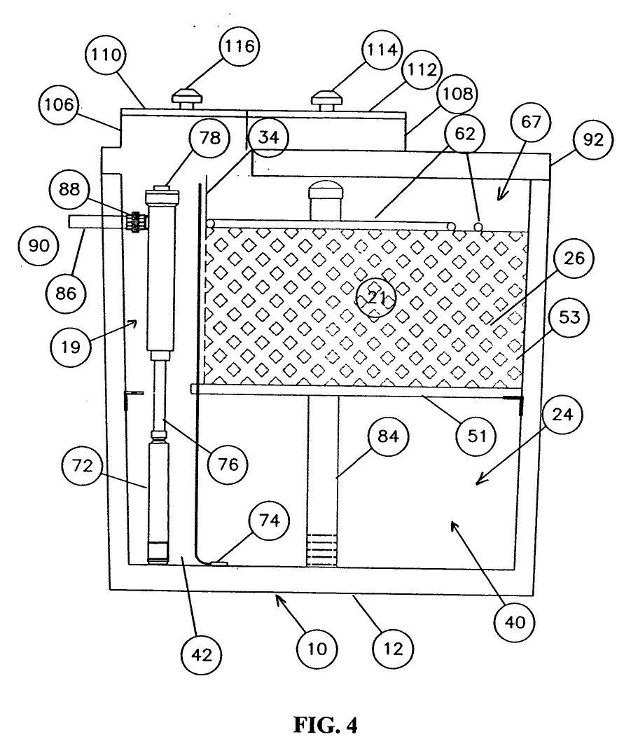

FIG. 5 is a sectional view taken along lines D-D of FIG. 1.

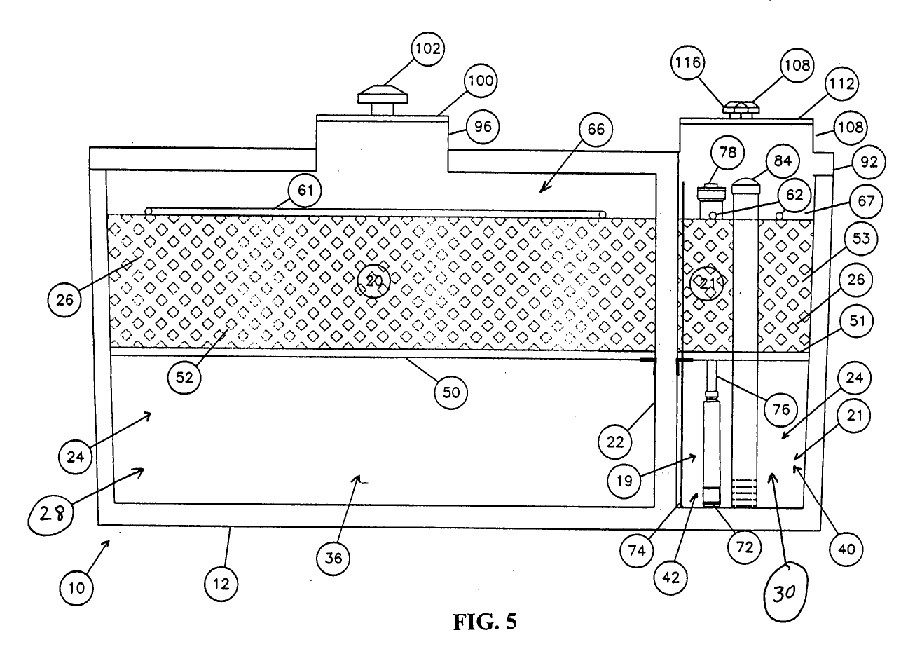

### DETAILED DESCRIPTION OF THE DRAWINGS

Referring now to the drawings, settled and screened wastewater from a septic tank or other primary treatment device enters the recirculation chamber 28 through influent pipe 48. The influent wastewater mixes with treated water falling from recirculation filter section 20 through underdrain 50 and is stored in the recirculation basin 36. The mixture of influent wastewater and treated effluent flows to recirculation pump 68. Recirculation pump 68 pumps the wastewater through distribution pipe 58 into the recirculation filter 54 which removes larger particles and prevents clogging of distribution piping and orifices, a typical filter being a model STF-100A2 pressure filter with a available from GAG Sim/Tech located in Boyne City, Mich. After passing through recirculation filter 54 the wastewater passes through a distribution pipe union 56 and enters the filter distribution pipe tee 57. The wastewater flow is split in filter distribution pipe tee 57 and is discharged into recirculation chamber distribution piping 61 and dosing chamber distribution piping 62, passing through recirculation distribution ball valve 59 and dosing distribution ball valve 60. Wastewater then flows through recirculation chamber distribution piping 61 and dosing chamber distribution piping 62 and is discharged from recirculation distribution pipe orifices 63 and dosing distribution pipe orifices 64. The recirculation distribution pipe orifices 63 and dosing distribution pipe orifices 64 discharge the wastewater upwards through recirculation chamber airspace 66 and dosing chamber airspace 67 and against the bottom of tank cover 92, which aerates the wastewater and distributes it across the recirculation filter section 20 and dosing filter section 21 and onto recirculation media 52 and dosing filter media 53.

A recirculation pump riser pipe 32 made of plastic or other lightweight material sets on recirculation filter underdrain 50 and prevents the recirculation filter media 52 from falling into the recirculation pump basin 38 and recirculation basin 36. A hole, slightly smaller than the diameter of recirculation pump riser pipe 32 is cut into recirculation filter underdrain 50 to allow recirculation pump 68 and distribution piping 58 to be lowered into place in recirculation basin 36. A filter distribution pipe union 56 on distribution piping 58 allows the recirculation pump 68, distribution piping 58 and recirculation filter 54 to be removed from recirculation basin 36 for servicing without entering the recirculation pump basin 38. Recirculation chamber distribution piping 61 can be periodically flushed out to prevent the buildup of solids in the piping by turning on recirculation pump 68, closing dosing distribution ball valve 60 and opening recirculation distribution piping flush valve 80 to flush recirculation chamber distribution piping 61 back into the recirculation pump basin 38. Dosing chamber distribution piping 62 can be periodically flushed out to prevent the buildup of solids in the piping by turning on recirculation pump 68, closing recirculation distribution ball valve 59 and opening dosing distribution piping flush valve 82 to flush dosing chamber distribution piping 62 back into the recirculation pump basin 38.

A recirculation basin level control 70, located in the recirculation chamber 28 measures the water level in the recirculation basin 36. A preferred recirculation basin level control is a pressure transducer. A typical pressure transducer is a submersible, stainless steel 4-20 mA output model available from Measurement Specialties, Inc. located in Hampton, Va. When the water level in the recirculation basin 36 reaches a programmed minimum level above the floor of recirculation chamber 28 as measured by recirculation basin level control 70, control panel 16 activates recirculation pump 68 to begin pumping to recirculation filter section 20 and dosing filter section 21 on a programmable time interval. The timed doses will repeat on a programmed schedule as long as the water level in the recirculation basin 36 remains above the programmed minimum level above the floor of recirculation chamber 28. If the water level in the recirculation basin 36 rises above a programmed maximum level above the floor of the recirculation chamber 28 as measured by recirculation basin level control 70, control panel 16 activates recirculation pump 68 to operate until a programmed drop in water level in recirculation basin 36 is achieved. If the water level in recirculation basin 36 does not drop after a programmed time or the level continues to rise, control panel 16 will signal a high recirculation basin alarm by activating an alarm light, audio alarm and a telephone dialer within control panel 16 to call and alert a service representative.

The wastewater discharged from recirculation distribution pipe orifices 63 and dosing distribution pipe orifices 64 is distributed over recirculation filter section 20 and dosing filter section 21 and flows through the recirculation filter media 52 and dosing filter media 53 by gravity. As the wastewater flows through the filter media it is treated by a combination of physical, chemical and aerobic biological processes. A preferred media is textile chips. Illustratively, the recirculation filter media 52 and dosing filter media 53 is a non-woven textile fabric composed of polyethylene filaments such as Type 4-17PE textile chips available from Texel, Inc. located in Quebec, Canada.

The treated effluent from recirculation filter section 20 flows through recirculation filter underdrain 50 consisting of fiberglass grating or materials of a similar design and falls back into the recirculation basin 36. The treated effluent from dosing filter section 21 flows through dosing filter underdrain 51 and falls into dosing basin 40. The placement of chamber dividing wall 22 within tank 12 determines the size of the recirculation chamber 28 and the dosing chamber 30. The areas of recirculation filter section 20 compared to the area of the dosing filter section 21 determines the recirculation ratio of the wastewater treatment apparatus 10. For example, if the recirculation filter area 20 is 40 square feet in size and the dosing filter section 21 is 10 square feet in size, the recirculation ratio would be equal to 40 square feet divided by 10 square feet and would create a recirculation ratio of 4:1. Typical recirculation ratios range from 3:1 to 5:1. The number of recirculation distribution pipe orifices 63 and dosing distribution pipe orifices 64 shall be in the same proportion as the recirculation ratio. For example, if there are 40 recirculation distribution pipe orifices in the 40 square feet recirculation filter section of the above example, there would need to be 10 dosing distribution pipe orifices in the 10 square feet dosing filter section of the same example.

A dosing basin level control 74 located in the dosing chamber 30 measures the water level in the dosing basin 40. A preferred dosing basin level control is a pressure transducer. A typical pressure transducer is a submersible, stainless steel 4-20 mA output model available from Measurement Specialties, Inc. located in Hampton, Va. When the water level in the dosing basin 40 reaches a programmed minimum level above the floor of the dosing chamber 30, the dosing basin level control 74 signals the control panel 16 to begin pumping to the effluent discharge pipe 76 on a programmable timed basis until a programmed level of water has been removed from the dosing basin 40. The doses will repeat on a programmed schedule as long as the water level in the dosing basin 40 remains above the programmed minimum level above the floor of the dosing chamber 30. If the water level in the dosing basin 40 rises above a programmed maximum level above the floor of the dosing chamber 30, the dosing basin level control 74 signals the control panel 16 to start dosing pump 72 and pump until a programmed drop in level is achieved. If the level in the dosing basin 40 does not drop after a programmed time or the level continues to rise, the control panel 16 will signal a high dosing basin alarm by activating an alarm light, audio alarm and a telephone dialer within control panel 16 to call and alert a service representative.

The treated filter effluent falling into the dosing basin 40 from dosing filter section 21 flows through the dosing chamber 30 to dosing pump 72. The dosing pump 72 pumps the treated effluent through the effluent discharge pipe 76 into a treated effluent filter 78, a typical filter being a model STF-100A2 pressure filter with a 100 micron sock available from GAG Sim/Tech located in Boyne City, Mich. The treated effluent passing through the treated effluent filter 78 is directed to discharge system 90 via effluent discharge pipe 76.

A dosing pump riser pipe 34 made of plastic or other lightweight material sets on dosing filter underdrain 51 and prevents the dosing filter media 53 from falling into the dosing pump basin 42 and dosing basin 40. A hole, slightly smaller than the diameter of dosing pump riser pipe 34 is cut into dosing filter underdrain 51 to allow dosing pump 72 and effluent discharge pipe 76 to be lowered into place in dosing basin 40. An effluent discharge pipe union 88 on effluent discharge pipe 76 allows the dosing pump 72, effluent discharge pipe 76 and treated effluent filter 78 to be removed from dosing basin 40 for servicing without entering the dosing pump basin 42.

An optional tablet chlorinator 84 consisting of a polyvinyl chloride pipe with slots located in the bottom of the pipe below the low water elevation may be located in the dosing chamber 30. The tablet chlorinator is filled with chlorine disinfectant tablets and capped at the top. The water flowing through the dosing basin 40 when dosing pump 72 is operating moves through the slotted pipe containing the chlorine tablets and slowly dissolves the tablets while imparting a chlorine residual in the treated effluent. The chlorine residual acts to disinfect the treated effluent by killing the pathogenic organisms in the effluent. The hardness and percentage of chlorine in the tablets can be regulated to produce the proper chlorine residual in the treated effluent to provide the necessary disinfection level. Alternately, other forms of treated effluent disinfection can be used such as ultraviolet light disinfection or ozonation.

Recirculation pump section riser 94 located over recirculation pump section 18 provides access to the recirculation pump 68 for maintenance. The recirculation pump section riser 94 is covered with recirculation pump section riser lid 98. Recirculation pump section riser lid includes recirculation pump section vent 104 to provide air to the recirculation pump section 18 while recirculation pump 68 is operating. Recirculation filter section riser 96 located over recirculation filter section 20 provides access to recirculation filter media 52, recirculation chamber distribution piping 61, recirculation filter underdrain 50 and recirculation basin 36. The recirculation filter section riser 96 is covered by recirculation filter section riser lid 100. Recirculation filter section riser lid 100 includes recirculation filter section vent 102 to provide free transfer of oxygen to recirculation chamber air space 66 and recirculation filter media 52.

Dosing pump section riser 106 located over dosing pump section 19 provides access to the dosing pump 72 for maintenance. The dosing pump section riser 106 is covered with dosing pump section riser lid 110. Dosing pump section riser lid 110 includes dosing pump section vent 116 to provide air to the dosing pump section 19 while dosing pump 72 is operating. Dosing filter section riser 108 located over dosing filter section 21 provides access to dosing filter media 53, dosing chamber distribution piping 62, dosing filter underdrain 51 and dosing basin 40. The dosing filter section riser 108 is covered by dosing filter section riser lid 112. Dosing filter section riser lid 112 includes dosing filter section vent 114 to provide free transfer of oxygen to dosing chamber air space 67 and dosing filter media 53.

| | |
|---|---|
| 10 | Wastewater Treatment Unit |
| 12 | Tank |
| 14 | Tank Lifting Notch |
| 16 | Control Panel |
| 17 | Control Panel Mounting Post |
| 18 | Recirculation Pump Section |
| 19 | Dosing Pump Section |
| 20 | Recirculation Filter Section |
| 21 | Dosing Filter Section |
| 22 | Chamber Dividing Wall |
| 24 | Pump Layer |
| 26 | Filter Layer |
| 28 | Recirculation Chamber |
| 30 | Dosing Chamber |
| 32 | Recirculation Pump Riser Pipe |
| 34 | Dosing Pump Riser Pipe |
| 36 | Recirculation Basin |
| 38 | Recirculation Pump Basin |
| 40 | Dosing Basin |
| 42 | Dosing Pump Basin |
| 44 | Recirculation Pump Basin Conduit |
| 46 | Dosing Pump Basin Conduit |
| 48 | Influent Pipe |
| 50 | Recirculation Filter Underdrain |
| 51 | Dosing Filter Underdrain |
| 52 | Recirculation Filter Media |
| 53 | Dosing Filter Media |
| 54 | Recirculation Pump Filter |
| 56 | Filter Distribution Pipe Union |
| 57 | Filter Distribution Pipe Tee |
| 58 | Filter Distribution Pipe |
| 59 | Recirculation Distribution Ball Valve |
| 60 | Dosing Distribution Ball Valve |
| 61 | Recirculation Chamber Distribution Piping |
| 62 | Dosing Chamber Distribution Piping |
| 63 | Recirculation Distribution Pipe Orifices |
| 64 | Dosing Distribution Pipe Orifices |
| 66 | Recirculation Chamber Air Space |
| 67 | Dosing Chamber Air Space |
| 68 | Recirculation Pump |
| 70 | Recirculation Basin Level Control |
| 72 | Dosing Pump |
| 74 | Dosing Basin Level Control |
| 76 | Effluent Discharge Pipe |
| 78 | Treated Effluent Filter |
| 80 | Recirculation Distribution Piping Flush Valve |
| 82 | Dosing Distribution Piping Flush Valve |
| 84 | Tablet Chlorinator |
| 86 | Disposal Discharge Pipe |
| 88 | Effluent Discharge Pipe Union |
| 90 | Discharge System |
| 92 | Tank Cover |
| 94 | Recirculation Pump Section Riser |
| 96 | Recirculation Filter Section Riser |
| 98 | Recirculation Pump Section Riser Lid |
| 100 | Recirculation Filter Section Riser Lid |
| 102 | Recirculation Filter Section Vent |
| 104 | Recirculation Pump Section Vent |
| 106 | Dosing Pump Section Riser |
| 108 | Dosing Filter Section Riser |
| 110 | Dosing Pump Section Riser Lid |
| 112 | Dosing Filter Section Riser Lid |
| 114 | Dosing Filter Section Vent |
| 116 | Dosing Pump Section Vent |

Although the invention has been described in detail with reference to certain preferred embodiments, variations and modifications exist within the scope and spirit of the present invention as described and defined in the following claims.

What is claimed is:

1. A wastewater treatment unit, comprising:
a tank having an interior region;
a divider located in the interior region of the tank to divide the interior region of the tank into two distinct chambers including a recirculation chamber and a dosing chamber having no direct fluid connection to said recirculation chamber;
a first filter layer containing filter media and being located above said recirculation chamber;
a second filter layer containing filter media and being located above said dosing chamber;
an influent pipe which directs wastewater entering said wastewater treatment unit into said recirculation chamber;
a recirculation pump located in said recirculation chamber, said recirculation pump pumping the wastewater from said recirculation chamber onto said first and second filter layers; and
an effluent discharge pipe connected to said dosing chamber, the wastewater being discharged from said wastewater treatment unit through said effluent discharge pipe for final disposal.

2. The wastewater treatment unit as recited in claim 1, wherein the tank includes a top surface and a bottom surface, the divider wall extending between the top and bottom surfaces to divide the wastewater treatment unit into the two distinct chambers.

3. The wastewater treatment unit as recited in claim 1, wherein an amount of wastewater which is proportionally distributed to the recirculation and dosing chambers is determined by the placement of said divider wall in the interior region.

4. The wastewater treatment unit as recited in claim 3, wherein the proportion of treated flow returning to the recirculation basin determines a recirculation ratio of the treatment process and a quality of the treated effluent.

5. The wastewater treatment unit as recited in claim 1, further comprising a recirculation pump riser pipe, a recirculation pump section riser, and a recirculation pump section riser lid to allow access and removal of the recirculation pump from the top of the ground without entering the recirculation pump chamber.

6. The wastewater treatment unit as recited in claim 1, further comprising a dosing pump located in said dosing chamber, said dosing pump pumping the wastewater from said dosing chamber through said effluent discharge pipe to disposal.

7. The wastewater treatment unit as recited in claim 6, further comprising a dosing pump riser pipe, a dosing pump section riser, and a dosing pump section riser lid to allow access and removal of the dosing pump from the top of the ground without entering the dosing pump chamber.

8. The wastewater treatment unit as recited in claim 1, further comprising a recirculation pump filter to reduce the likelihood of solids plugging downstream processes, a recirculation piping union to allow removal of the recirculation pump without entering the recirculation pump chamber, a recirculation distribution pipe tee to split the recirculation pump flow between the recirculation filter section and dosing filter section, a recirculation distribution piping ball valve to isolate the recirculation filter distribution piping for flushing, a recirculation distribution piping network covering the recirculation filter section, recirculation piping orifices, and a recirculation distribution piping flush valve to allow flushing of said piping back into the recirculation pump chamber.

9. The wastewater treatment unit as recited in claim 8, further comprising recirculation piping orifices that spray wastewater upwards, impacting the top cover of the wastewater treatment unit, aerating said wastewater to provide oxygen to beneficial bacteria in the filter media, and distributing wastewater evenly over the filter bed area.

10. The wastewater treatment unit as recited in claim 9, further comprising a recirculation filter section vent, and a dosing filter section vent in the riser section lids, said vents having an outside vent opening open to the atmosphere, and an opening into the recirculation and dosing chamber air spaces above said filter media of the first and second filter layers, wherein the wastewater pumped through said filter distribution piping and spray nozzle assembly is sprayed into said air spaces.

11. The wastewater treatment unit as recited in claims 6, further comprising recirculation pump section vent, and dosing pump section vent in riser section lids, said vents having an outside vent opening open to the atmosphere, and an opening into the pump chambers to allow sufficient air for the pumps to discharge water from the respective storage basins.

12. The wastewater treatment unit as recited in claim 1, further comprising a porous filter underdrain, the wastewater flowing through said filter media of said first and second filter layers being directed through said underdrain and being directed into the recirculation chamber and the dosing chamber, respectively.

13. The wastewater treatment unit as recited in claim 1, further comprising a treated effluent filter on said treated effluent discharge pipe, said effluent filter preventing solids from being discharged from said treatment unit.

14. The wastewater treatment unit as recited in claim 6, further comprising a dosing basin level control, said dosing basin level control activating said dosing pump when the level of wastewater in said dosing chamber reaches a predetermined dosing pump activation level.

15. The wastewater treatment unit as recited in claim 14, further comprising a dosing pump timer; said dosing pump timer periodically activating said dosing pump, said dosing basin level control disabling activation of said dosing pump when the level of wastewater in said dosing chamber is below a predetermined dosing chamber minimum level, or enabling activation of said dosing pump when the level of wastewater in said dosing chamber is above a predetermined operating level.

16. The wastewater treatment unit as recited in claim 1, further comprising a recirculation pump timer, said recirculation pump timer periodically activating said recirculation pump.

17. The wastewater treatment unit as recited in claim 1, further comprising a recirculation basin level control, said recirculation basin level control activating said recirculation pump when the level of wastewater in said recirculation chamber reaches a predetermined recirculation chamber maximum level.

18. The wastewater treatment unit as recited in claim 17, further comprising a control system including a recirculation basin level control, a recirculation pump timer and a recirculation chamber level alarm; said recirculation pump being activated periodically by said recirculation pump timer; said recirculation pump being activated and said recirculation chamber level alarm being triggered by said recirculation basin level control when the level of wastewater in said recirculation chamber reaches a predetermined recirculation pump maximum level.

19. The wastewater treatment unit as recited in claim 1, further comprising a control system including a recirculation basin level control, a dosing basin level control, a recirculation pump timer, a dosing pump timer, a recirculation chamber level alarm, and a dosing chamber level alarm; said recirculation pump timer periodically activating said recirculation pump; said recirculation basin level control activating said recirculation pump and said recirculation chamber level alarm when the level of wastewater in said recirculation chamber reaches a predetermined recirculation chamber maximum level; said dosing pump timer periodically activating said dosing pump; said dosing basin level control activating said dosing pump when the level of wastewater in said dosing chamber reaches a predetermined dosing pump activation level; said dosing basin level control deactivating said dosing pump when a predetermined level of wastewater has been removed from said dosing chamber; said dosing basin level control activating said dosing chamber level alarm when the level of wastewater in said dosing chamber reaches a predetermined dosing chamber maximum level; said dosing basin level control disabling activation of said dosing pump by said dosing pump timer when the level of wastewater in said dosing chamber is below a predetermined dosing pump minimum level, and wherein said control system includes a modem card, said modem card being activated by at least one of said recirculation chamber level alarm and said dosing chamber level alarm; said modem card, when activated, initiating a call to preset phone numbers to notify a responsible person of at least one of said recirculation chamber level alarm and said dosing chamber level alarm.

20. The wastewater treatment unit as recited in claim 1, further comprising a tablet chlorinator installed in said dosing chamber, providing chemical chlorine to said treated effluent for disinfection.
